(19) United States
(12) Patent Application Publication
(10) Pub. No.: US 2017/0008278 A1
(43) Pub. Date: Jan. 12, 2017

(54) INKJET HEAD AND INKJET PRINTER

(71) Applicant: TOSHIBA TEC KABUSHIKI KAISHA, Tokyo (JP)

(72) Inventors: Teruyuki Hiyoshi, Izunokuni (JP); Noboru Nitta, Tagata (JP)

(21) Appl. No.: 15/138,546

(22) Filed: Apr. 26, 2016

(30) Foreign Application Priority Data
Jul. 6, 2015 (JP) 2015-135247

(51) Int. Cl. B41J 2/045

(52) U.S. Cl. CPC B41J 2/04541; B41J 2/04581

(57) ABSTRACT

An inkjet head comprises a pressure chamber into which ink is filled, a nozzle connected with the pressure chamber, an actuator which changes volume of the inside of the pressure chamber to eject an ink droplet from the nozzle connected with the pressure chamber, and a drive circuit which outputs a drive signal which contains an expansion pulse for increasing the volume of the pressure chamber and a contraction pulse for decreasing the volume of the pressure chamber when an ink droplet is ejected and outputs a precursor signal for changing the volume of the pressure chamber to a level at which the ink droplet is not ejected from the nozzle at the time of a precursor minute vibration for minutely vibrating ink.

### CROSS-REFERENCE TO RELATED APPLICATION

This application is based upon and claims the benefit of priority from Japanese Patent Application No. 2015-135247, filed Jul. 6, 2015, the entire contents of which are incorporated herein by reference.

### FIELD

Embodiments described herein relate generally to an inkjet head and an inkjet printer using the inkjet head.

### BACKGROUND

An inkjet head comprises a pressure chamber into which ink is filled, an actuator arranged in the pressure chamber and a nozzle connected with the pressure chamber. In the inkjet head, if a drive signal is applied to the actuator, the pressure chamber vibrates through the function of the actuator, and volume of the inside of the pressure chamber changes, and thus an ink droplet is ejected from the nozzle connected with the pressure chamber.

In this kind of inkjet head, as meniscus of ink is not changed, there is a problem that intermittent ejection property of the nozzle which ejects no ink droplet deteriorates. Thus, in order to improve the intermittent ejection property, a technology which enables the inkjet head to execute precursor minute vibration to be executed in the inkjet head is known. The precursor minute vibration is a technology which vibrates the meniscus of the ink in advance at a level at which the ink is not ejected from the nozzle.

In order to achieve the technology, a drive circuit of the inkjet head applies a pulse signal for performing the precursor minute vibration to the actuator, in other words, applies a precursor signal. In the conventional inkjet head, the actuator generates a precursor signal which has the same potential with the drive signal. Thus, not only at the applying time of the drive signal, that is, the time relating to ejection of the ink droplet, but also at the applying time of the precursor signal, that is, the time that does not relate to the ejection of the ink droplet, as electric field with the same potential is generated with respect to the actuator, it is afraid that extra electric power is consumed.

### BRIEF DESCRIPTION OF DRAWINGS

FIG. 1 is an exploded perspective view illustrating a part of an inkjet head;

FIG. 2 is a longitudinal sectional view of the inkjet head at the front section thereof;

FIG. 3 is a cross-sectional view of the inkjet head at the front section thereof;

FIG. 4 is a diagram illustrating an operation principle of the inkjet head;

FIG. 5 is a block diagram illustrating a hardware structure of an inkjet printer;

FIG. 6 is a block diagram illustrating a concrete structure of a head drive circuit in the inkjet printer;

FIG. 7 is a schematic circuit diagram illustrating a buffer circuit and a switching circuit contained in the head drive circuit;

FIG. 8 is a waveform diagram illustrating a relationship between a conventional drive signal or precursor signal and electric field generated in an actuator;

FIG. 9 is a waveform diagram illustrating a relationship between a drive signal or precursor signal of the present embodiment and electric field generated in the actuator;

FIG. 10 is a graph illustrating electric field generated in the actuator and pressure in the pressure chamber of an ejecting channel when 5 drops are ejected in a gradation printing in which the maximal number of drops is 7;

FIG. 11 is a graph illustrating electric field generated in the actuator and pressure in the pressure chamber of the ejecting channel when 2 drops are ejected in the gradation printing in which the maximal number of drops is 7;

FIG. 12 is a graph illustrating electric field generated in the actuator and pressure in the pressure chamber of the ejecting channel when no drop is ejected in the gradation printing in which the maximal number of drops is 7;

FIG. 13 is a schematic diagram illustrating a measurement circuit of a drive current;

FIG. 14 is a waveform diagram illustrating a drive current when the conventional precursor signal is applied to the inkjet head; and

FIG. 15 is a waveform diagram illustrating a drive current when conventional the precursor signal of the present embodiment is applied to the inkjet head.

### DETAILED DESCRIPTION

In an embodiment, an inkjet head comprises a pressure chamber into which ink is filled, a nozzle configured to be connected with the pressure chamber, an actuator configured to change volume of the inside of the pressure chamber to eject an ink droplet from the nozzle connected with the pressure chamber and a drive circuit. The drive circuit outputs a drive signal which contains an expansion pulse for increasing the volume of the pressure chamber and a contraction pulse for decreasing the volume of the pressure chamber at the time of ejection of an ink droplet and outputs a precursor signal for changing the volume of the pressure chamber to a level at which the ink droplet is not ejected from the nozzle at the time of precursor minute vibration for minutely vibrating the ink. Further, the drive circuit outputs the precursor signal in such a manner that electric field generated in the actuator according to the precursor signal is smaller than that generated in the actuator according to the drive signal.

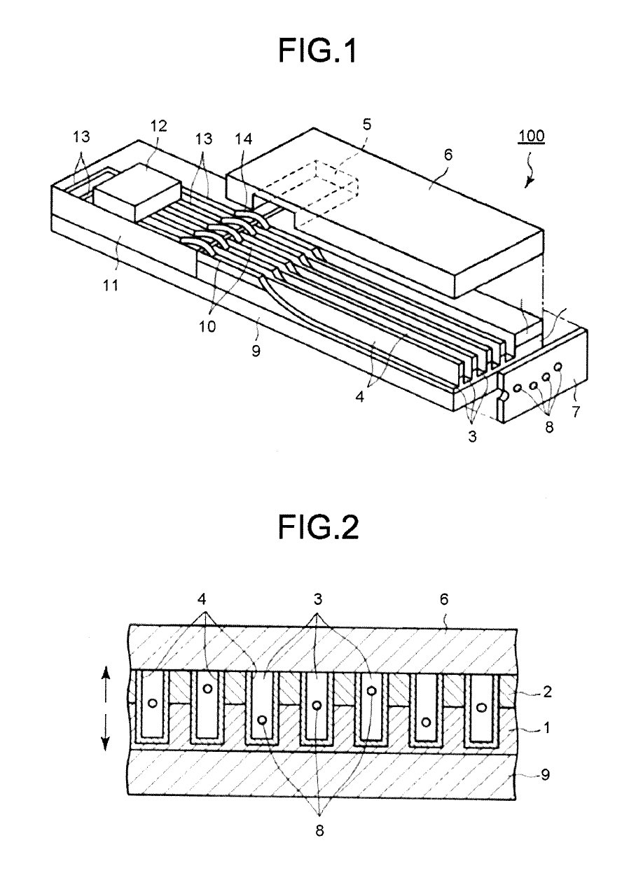

Hereinafter, the inkjet head according to the embodiment and an inkjet printer using the inkjet head are described with reference to the accompanying drawings. Incidentally, in the embodiment, an inkjet head 100 (refer to FIG. 1) of a share-mode type is exemplified as the inkjet head.

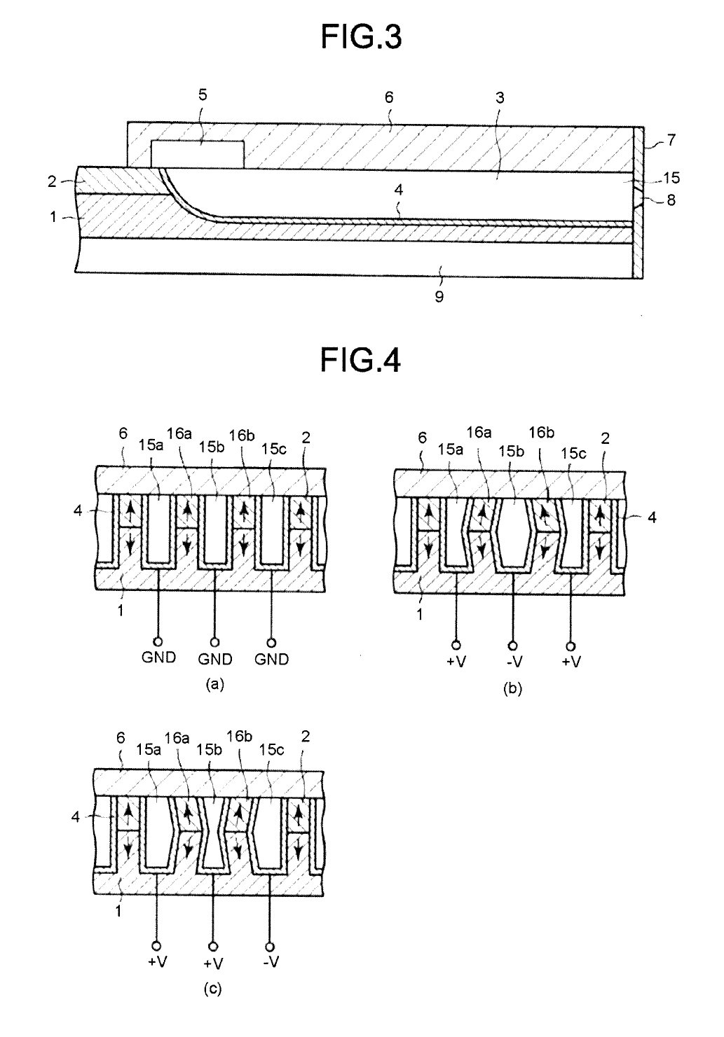

Firstly, the structure of the inkjet head 100 (hereinafter, abbreviated to a head 100) is described with reference to FIG. 1 to FIG. 3. FIG. 1 is an exploded perspective view illustrating a part of the head 100. FIG. 2 is a longitudinal sectional view of the head 100 at the front section thereof. FIG. 3 is a cross-sectional view of the head 100 at the front section thereof.

The head 100 is equipped with a base substrate 9. The head 100 bonds a first piezoelectric member 1 to the upper surface at the front side of the base substrate 9 and bonds a second piezoelectric member 2 on the first piezoelectric member 1. The bonded first piezoelectric member 1 and second piezoelectric member 2 are polarized in the manually opposite directions along the thickness direction of the base substrate 9 as shown by arrows of FIG. 2.

The base substrate 9 is made from a material which has a small dielectric constant and of which the difference in thermal expansion coefficient from the piezoelectric members 1 and 2 is small. As a material of the base substrate 9, for example, alumina (Al203), silicon nitride (Si3N4), silicon carbide (SiC), aluminum nitride (AlN) and lead zirconic titanate (PZT) are preferable. On the other hand, as a material of the piezoelectric members 1 and 2, lead zirconic titanate (PZT), lithium niobate (LiNbO3) and lithium tantalate (LiTaO3) are used.

The head 100 arranges a plurality of long grooves 3 from the front end side towards the rear end side of the bonded piezoelectric members 1 and 2. The grooves 3 are arranged with a given interval successively therebetween and in parallel with each other. The front end of each groove 3 is opened and the rear end thereof is inclined upwards.

The head 100 arranges an electrode 4 on side walls and the bottom of each groove 3. The electrode 4 has a two-layer structure consisting of nickel (Ni) and aurum (Au). The electrode 4 is formed uniformly in each groove 3 with an electrochemical plating method. The forming method of the electrode 4 is not limited to the electrochemical plating method. In addition, a sputtering method or an evaporation method may also be used.

The head 100 arranges an extraction electrode 10 from rear end of each groove 3 towards an upper surface of rear side of the second piezoelectric member 2. The extraction electrode 10 extends from the electrode 4.

The head 100 includes a top plate 6 and an orifice plate 7. The top plate 6 seals the top of each groove 3. The orifice plate 7 seals the front end of each groove 3. In the head 100, a plurality of pressure chambers 15 is formed with the grooves 3 each of which is sealed by the top plate 6 and the orifice plate 7. The pressure chambers 15, for example, each of which has a depth of 300 μm and a width of 80 μm, are arranged in parallel at an interval of 169 μm. Such a pressure chamber 15 is referred to as an ink chamber.

The top plate 6 comprises a common ink chamber 5 at the rear of the inside thereof. The orifice plate 7 arranges a nozzle 8 at a position opposite to the groove 3. The nozzles 8 are connected with the grooves 3, in other words, the pressure chambers 15 facing the nozzles 8. The nozzle 8 is formed into a taper shape from the pressure chamber 15 side towards the ink ejection side of the opposite side to the pressure chamber 15 side. The nozzles 8 are formed successively at a given interval in a height direction (vertical direction of paper surface of FIG. 2) of the groove 3 and three nozzles 8 corresponding to the adjacent three pressure chambers 15 are assumed as a set.

The head 100 bonds a printed substrate 11 on which conductive patterns 13 are formed to the upper surface of the rear side of the base substrate 9. The head 100 carries a drive IC 12 in which a head drive circuit 101 described later is mounted on the printed substrate 11. The drive IC 12 is connected with the conductive patterns 13. The conductive patterns 13 are connected with each extraction electrode 10 via conducting wires 14 through a wire bonding.

A set consisting of a pressure chamber 15, an electrode 4 and a nozzle 8 included in the head 100 is referred to as a channel. That is, the head 100 includes channels ch.1, ch.2 . . . , ch.N, wherein the number of channels is N corresponding to the number of grooves 3.

Next, an operation principle of the head 100 with a structure as described above is described with the use of FIG. 4.

FIG. 4 (a) illustrates a state in which the potential of each electrode 4 which is respectively arranged on each wall surface of a pressure chamber 15b in the center and pressure chambers 15a and 15c adjacent to both sides of the pressure chamber 15b is grounding potential GND. In such a state, no distortion effect acts on both a bulkhead 16a sandwiched the pressure chamber 15a pressure chamber 15a bulkhead 16b sandwiched by the pressure chamber 15b and the pressure chamber 15c.

FIG. 4(b) illustrates a state in which the electrode 4 of the central pressure chamber 15b is applied with a voltage of −V having negative polarity and the electrodes 4 of the two adjacent pressure chambers 15a and 15c are applied with a voltage of +V having positive polarity. In such a state, the electric field which is twice as large as that of the voltage of V acts on the bulkheads 16a and 16b in a direction orthogonal to the polarized direction of the piezoelectric members 1 and 2. Through such an operation, each of the bulkheads 16a and 16b is deformed towards outside such that the volume of the pressure chamber 15b is increased.

FIG. 4(c) illustrates a state in which the electrode 4 of the central pressure chamber 15b is applied with a voltage of +V having positive polarity and the electrodes 4 of the two adjacent pressure chambers 15a and 15c are applied with a voltage of −V having negative polarity. In such a state, the electric field which is twice as large as that of the voltage of V acts on the bulkheads 16a and 16b in a direction reverse to that shown in FIG. 4(b). Through such an operation, each of the bulkheads 16a and 16b is deformed towards inside such that the volume of the pressure chamber 15b is decreased.

In a case in which the volume of the pressure chamber 15b is increased or decreased, pressure vibration occurs in the pressure chamber 15b. Through the pressure vibration, the pressure in the pressure chamber 15b is increased, and an ink droplet is ejected from the nozzle 8 which is connected with the pressure chamber 15b.

In this way, the bulkheads 16a and 16b which separate the pressure chambers 15a, 15b and 15c become actuators for applying the pressure vibration to the inside of the pressure chamber 15b which takes the bulkheads 16a and 16b as wall surfaces. That is, each pressure chamber 15 shares the actuator with adjacent pressure chambers 15 respectively. Thus, the head drive circuit 101 cannot drive each pressure chamber 15 separately. The head drive circuit 101 drives the pressure chamber 15 in a manner of segmenting the pressure chambers 15 into (n+1) (n is an integer which is equal to or greater than 2) groups every n pressure chambers. In the present embodiment, a case in which the head drive circuit 101 carries out a division driving in such a manner that the pressure chambers 15 is segmented into 3 groups every 2 pressure chambers, that is, 3 division driving is exemplified. Further, 3 division driving is only an example, and 4 division driving or 5 division driving may also be applicable.

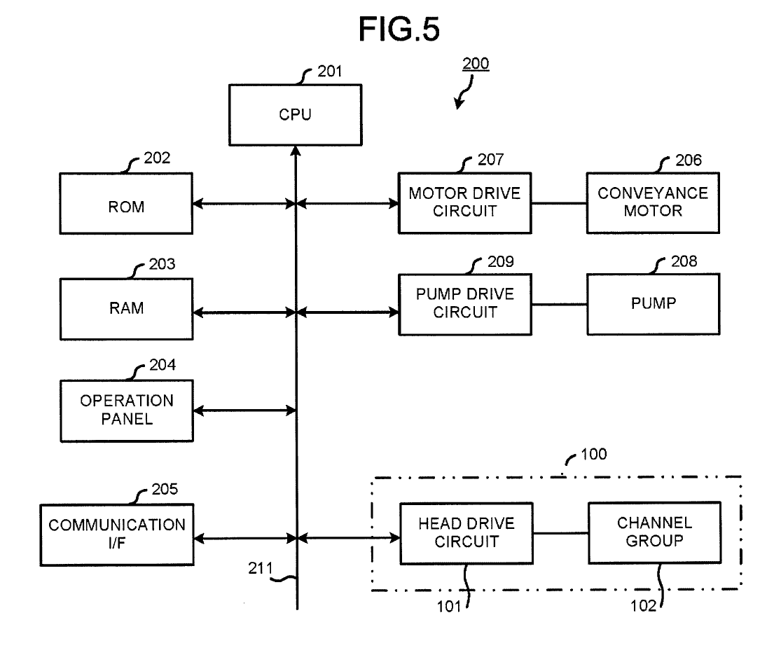

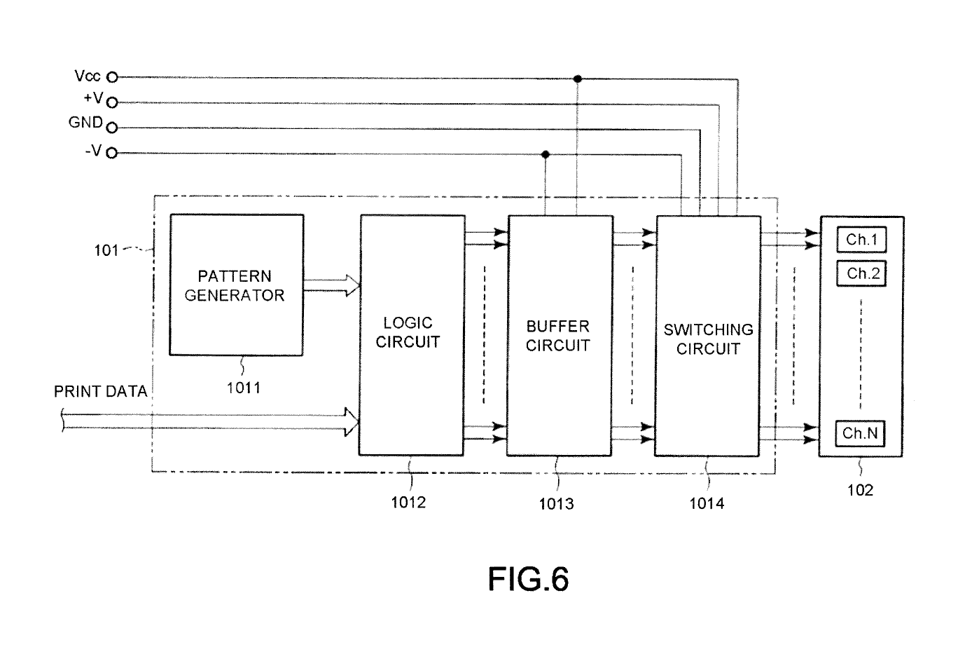

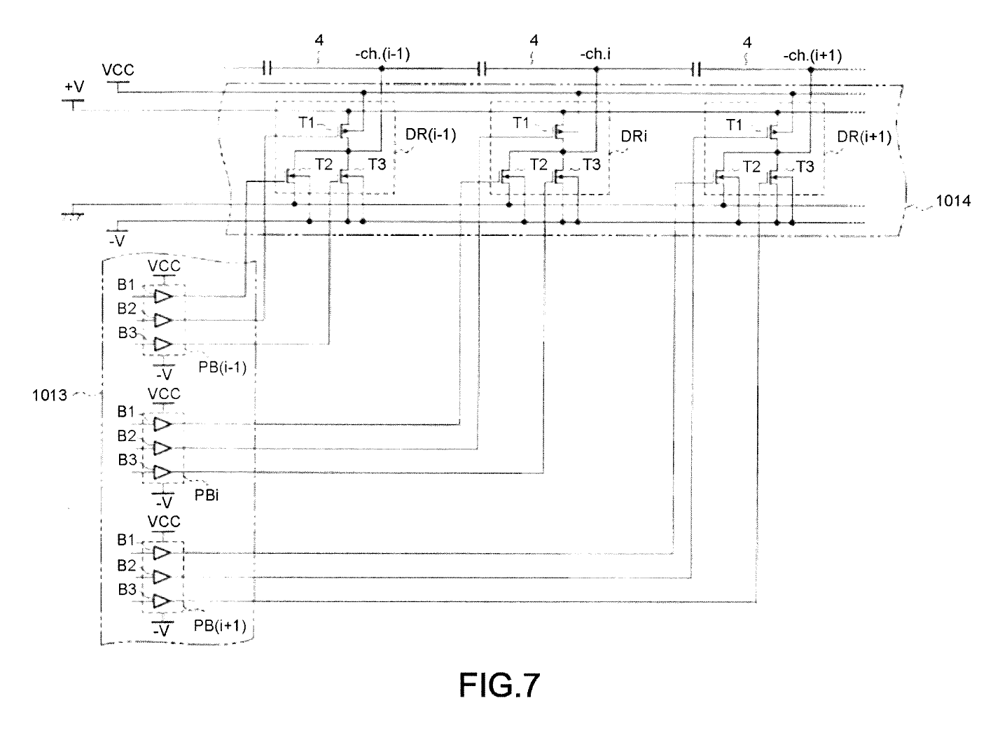

Next, the structure of an inkjet printer 200 (Hereinafter, abbreviated to a printer 200) is described with reference to FIG. 5-FIG. 7. FIG. 5 is a block diagram illustrating a hardware structure of the printer 200. FIG. 6 is a block diagram illustrating a concrete structure of the head drive circuit 101, and FIG. 7 is a schematic circuit diagram illustrating a buffer circuit 1013 and a switching circuit 1014 contained in the head drive circuit 101. The printer 200 may be a printer for office, a barcode printer, a printer for POS or a printer for industry.

The printer 200 comprises a CPU (Central Processing Unit) 201, a ROM (Read Only Memory) 202, a RAM (Random Access Memory) 203, an operation panel 204, a communication interface 205, a conveyance motor 206, a motor drive circuit 207, a pump 208, a pump drive circuit 209 and the head 100. The printer 200 further comprises a bus line 211 such as an address bus line, a data bus line and the like. The printer 200 connects the CPU 201, the ROM 202, the RAM 203, the operation panel 204, the communication interface 205, the motor drive circuit 207, the pump drive circuit 209 and the head drive circuit 101 of the head 100 with the bus line 211 directly or via an input/output circuit.

The CPU 201 acting as a central part of a computer controls each section to realize various functions of the printer 200 according to an operating system or application programs.

The ROM 202 acting as a main storage part of the foregoing computer stores the foregoing operating system or application programs. The ROM 202, in some cases, also stores data required to execute processing for controlling each section by the CPU 201.

The RAM 203 acting as a main storage part of the foregoing computer stores data required to execute processing by the CPU 201. The RAM 203 is also used as a working area for suitably rewriting information by the CPU 201. The working area includes an image memory in which print data is copied or decompressed.

The operation panel 204 includes an operation section and a display section. The operation section includes functional keys such as a power source key, a paper feeding key, an error cancellation key and the like. The display section can display various states of the printer 200.

The communication interface 205 receives print data from a client terminal that is connected with the printer 200 via a network such as an LAN (Local Area Network). The communication interface 205, for example, when an error occurs in the printer 200, sends a signal for notifying the error to the client terminal.

The motor drive circuit 207 controls to drive the conveyance motor 206. The conveyance motor 206 functions as a drive source of a conveyance mechanism which conveys an image receiving medium such as a printing paper. If the conveyance motor 206 is driven, the conveyance mechanism starts to convey the image receiving medium. The conveyance mechanism conveys the image receiving medium to a printing position where the image receiving medium is printed with the head 100. The conveyance mechanism discharges the image receiving medium the printing on which is terminated to the outside of the printer 200 via a discharging port (not shown).

The pump drive circuit 209 controls to drive the pump 208. If the pump 208 is driven, the ink in an ink tank (not shown) is supplied to the head 100.

The head drive circuit 101 drives a channel group 102 of the head 100 based on the print data. The head drive circuit 101 includes, as shown in FIG. 6, a pattern generator 1011, a logic circuit 1012, a buffer circuit 1013 and a switching circuit 1014.

The pattern generator 1011 generates waveform patterns consisting of an ejecting relevant waveform, an ejecting two-adjacent waveform, a non-ejecting relevant waveform and a non-ejecting two-adjacent waveform. The data of a waveform pattern generated by the pattern generator 1011 is supplied to the logic circuit 1012.

The logic circuit 1012 receives input of the print data read line by line from the image memory. If the print data is input, the logic circuit 1012 sets three adjacent channels ch. (i−1), ch.i and ch. (i+1) of the head 100 as one set and determines whether the central channel ch.i is an ejecting channel that ejects ink or a non-ejecting channel that does not eject ink. If the channel ch.i is the ejecting channel, the logic circuit 1012 outputs pattern data of the ejecting relevant waveform to the channel ch.i and outputs pattern data of the ejecting two-adjacent waveform to two adjacent channels ch. (i−1) and ch. (i+1). If the channel ch.i is the non-ejecting channel, the logic circuit 1012 outputs pattern data of the non-ejecting relevant waveform to the channel ch.i and outputs pattern data of non-ejecting two-adjacent waveform to the two adjacent channels ch. (i−1) and ch. (i+1). Each pattern data output from the logic circuit 1012 is supplied to the buffer circuit 1013.

The buffer circuit 1013 is connected with a power source of a positive voltage Vcc and a power source of a negative voltage −V. The buffer circuit 1013, as shown in FIG. 7, includes pre-buffers PB1, PB2, . . . , PBN for each of channels ch.1, ch.2, . . . , ch.N of the head 100. Furthermore, in FIG. 7, pre-buffers PB (i-1), PBi and PB (i+1) corresponding to three adjacent channels ch. (i-1), ch.i and ch. (i+1) are shown.

Each of pre-buffers PB1, PB2, . . . , PBN includes first to third buffers B1, B2 and B3, that is, three buffers respectively. Each of buffers B1, B2 and B3 is connected with a power source of a positive voltage Vcc and a power source of a negative voltage −V respectively.

In each of pre-buffers PB1, PB2, . . . , PBN, the output of the first to third buffers B1, B2 and B3 varies according to the levels of signals supplied from the logic circuit 1012. The signals of different levels are supplied from the logic circuit 1012 according to whether the corresponding channel ch.k (1≦k≦N) is an ejecting channel, a non-ejecting channel or a channel which is adjacent to the ejecting channel or the non-ejecting channel. The first to third buffers B1, B2 and B3 to which a high level signal is supplied output a signal of a positive voltage Vcc level. The first to third buffers B1, B2 and B3 to which a low level signal is supplied output a signal of a negative voltage −V level.

The output of each of pre-buffers PB1, PB2, . . . , PBN, in other words, the output signal of the first to third buffers B1, B2 and B3 is supplied to the switching circuit 1014.

The switching circuit 1014 is connected with a power source of a positive voltage Vcc, a power source of a positive voltage +V, a power source of a negative voltage −V and a grounding potential GND. The positive voltage Vcc is higher than the positive voltage +V. As a representative value, the positive voltage Vcc is 24 volts and the positive voltage +V is −15 volts. In this case, the negative voltage −V is −15 volts.

The switching circuit 1014, as shown in FIG. 7, includes drivers DR1, DR2, . . . , DRN respectively for the channels ch.1, ch.2, . . . , ch.N of the head 100. Furthermore, in FIG. 7, drivers DR (i−1), DRi and DR (i+1) respectively corresponding to three adjacent channels ch. (i1), ch.i and ch. (i+1) are shown.

Each of drivers DR1, DR2, . . . , DRN includes an electric field effect transistor T1 (hereinafter, referred to as a first transistor T1) of a PMOS type and two electric field effect transistors T2 and T3 (hereinafter, referred to as a second transistor T2 and a third transistor T3) of an NMOS type. Each of drivers DR1, DR2, DRN is connected with a series circuit constituted by the first transistor T1 and the second transistor T2 between the power source of the positive voltage +V and the grounding potential GND, and further connected with the third transistor T3 between a connecting point of the first transistor T1 and the second transistor T2 and the power source of the negative voltage −V. Each of drivers DR1, DR2, . . . , DRN connects a back gate of the first transistor T1 with the power source of the positive voltage Vcc and connects back gates of the second transistor and the third transistor with the power source of the negative voltage −V respectively. Further, each of drivers DR1, DR2, . . . , DRN connects the first buffer B1 of each of corresponding pre-buffers PB1, PB2, . . . , PBN with a gate of the second transistor T2, connects the second buffer B2 with a gate of the first transistor T1 and connects the third buffer B3 with a gate of the third transistor T3. Then, each of drivers DR1, DR2, . . . , DRN applies the potential of the connecting point of the first transistor T1 and the second transistor T2 to the electrode 4 of each of corresponding channels ch.1, ch.2, . . . , ch.N respectively.

Thus, the first transistor T1 is turned off if a signal of the positive voltage Vcc level from the second buffer B2 is input, and is turned on if a signal of the negative voltage −V level is input. The second transistor T2 is turned on if a signal of the positive voltage Vcc level from the first buffer B1 is input, and is turned off if a signal of the negative voltage −V level is input. The third transistor T3 is turned on if a signal of the positive voltage Vcc level from the third buffer B3 is input, and is turned off if a signal of the negative voltage −V level is input.

The drivers DR1, DR2, . . . , DRN each having such a structure apply the positive voltage +V to the electrodes 4 of corresponding channels ch.1, ch.2, . . . , ch.N if the first transistor T1 is turned on and the second transistor T2 and the third transistor T3 are turned off. The drivers DR1, DR2, . . . , DRN set the potential of the electrodes 4 of corresponding channels ch.1, ch.2, . . . , ch.N to the grounding GND level if the first transistor T1 and the third transistor T3 are turned off simultaneously, and the second transistor T2 is turned on. The drivers DR1, DR2, . . . , DRN apply the negative voltage −V to the electrodes 4 of corresponding channels ch.1, ch.2, . . . , ch.N if the first transistor T1 and the second transistor T2 are turned off simultaneously, and the third transistor T3 is turned on.

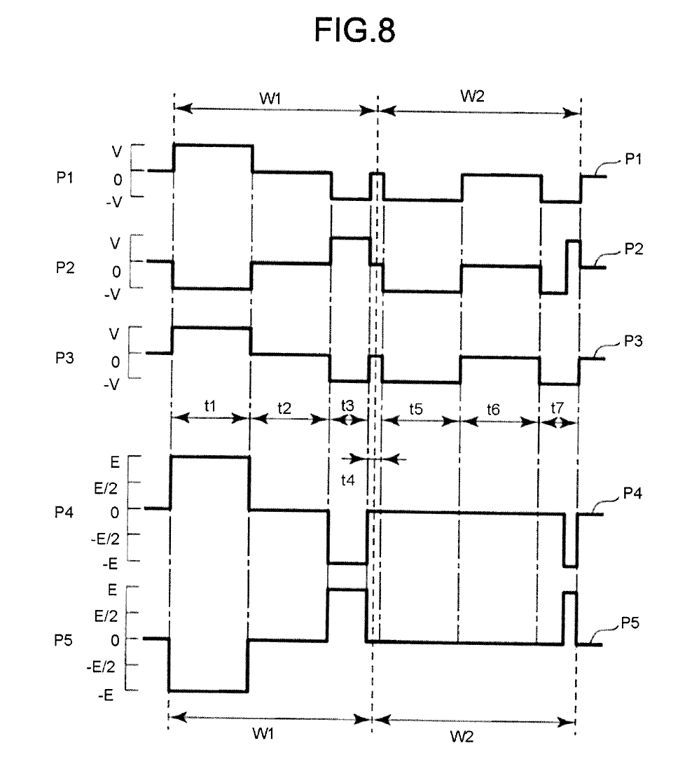

Next, the relationship between the drive signal or the precursor signal supplied from the head drive circuit 101 to the channel group 102 and the electric field generated in the actuator is described. Initially, the relationship between the conventional pulse signal and the electric field is described with reference to FIG. 8.

FIG. 8 shows a case in which among three adjacent channels ch. a, ch. b and ch. c, one drop is ejected from the central channel ch. b, and afterwards, the precursor minute vibration is generated in the central channel ch.b.

A pulse waveform P1 shows the drive signal and the precursor signal to be supplied to the channel ch. a. A pulse waveform P2 shows the drive signal and the precursor signal to be supplied to the channel ch.b. A pulse waveform P3 shows the drive signal and the precursor signal to be supplied to the channel ch.c. That is, the pulse waveform P2 is a signal according to pattern data of a first ejecting relevant waveform generated by the pattern generator 1011. The pulse waveforms P1 and P3 are signals according to pattern data of a first ejecting two-adjacent waveform generated by the pattern generator 1011.

A pulse waveform P4 shows a fluctuation waveform of the electric field generated in the first actuator, that is, in the bulkhead 16a serving as one side of the channel ch.b. A pulse waveform P5 shows a fluctuation waveform of the electric field generated in the second actuator, that is, in the bulkhead 16b serving as the other side of the channel ch.b. In other words, orientation and polarity of the electric field generated in the second actuator are reverse to orientation and polarity of the electric field generated in the first actuator.

In FIG. 8, a period W1 is required for ejecting one drop. During the period W1, the head drive circuit 101 outputs the drive signals shown by the pulse waveforms P1, P2 and P3 only at a first time t1 first. Through these drive signals, the negative voltage −V is applied to the central channel ch.b and the positive voltage +V is applied to the two adjacent channels ch.a and ch.c. As a result, as shown in the pulse waveforms P4 and P5, electric field “+E” is generated in the first actuator, and electric field “−E” is generated in the second actuator. Through such a fluctuation of the electric field, as shown in FIG. 4(b) the pressure chamber 15b corresponding to the channel ch.b is expanded and the ink is supplied to the pressure chamber 15b. Herein, the drive signals shown by the pulse waveforms P1, P2 and P3 that are output at the first time t1 are referred to as expansion pulses.

Then, the head drive circuit 101 outputs the drive signals shown by the pulse waveforms 21, P2 and P3 only at a second time t2. Through these drive signals, the voltage applied to each of channels ch.a, ch.b and ch.c returns to the grounding potential GND. As a result, as shown in the pulse waveforms P4 and P5, the electric fields of the first and the second actuators both become “0”. Through such a fluctuation of the electric field, as shown in FIG. 4(a), the volume of the pressure chamber 15b corresponding to the channel ch.b returns to a steady state. Through the fluctuation of the volume at this time, the pressure of the pressure chamber 15b is increased and the ink droplet is ejected from the nozzle 8 connected with the pressure chamber 15b.

Next, the head drive circuit 101 outputs the drive signals shown by the pulse waveforms P1, P2 and 23 only at a third time t3. Through these drive signals, the positive voltage +V is applied to the central channel ch.b and the negative voltage −V is applied to the two adjacent channels ch.a and ch.c. As a result, as shown in the pulse waveforms P4 and P5, the electric field “−E” is generated in the first actuator and the electric field “+E” is generated in the second actuator. Through such a fluctuation of the electric field, as shown in FIG. 4(c), the pressure chamber 15b corresponding to the channel ch.b is contracted. Through the fluctuation of the volume at this time, pressure vibration in the pressure chamber 15b after the ejection of the ink is suppressed. Herein, the drive signals shown by the pulse waveforms P1, P2 and P3 output at the third time t3 are referred to as contraction pulses.

Afterwards, the head drive circuit 101 outputs the drive signals shown by the pulse waveforms P1, P2 and P3 only at a fourth time t4. Through these drive signals, the voltage applied to each of channels ch.a, ch.b and ch. c returns to the grounding potential GND. As a result, as shown in the pulse waveforms P4 and P5, the electric fields of the first and the second actuators both become “0”. Such a fluctuation of the electric field, as shown in FIG. 4(a), the volume of the pressure chamber 15b corresponding to the channel ch.b returns to the steady state.

In FIG. 8, a period W2 is required for generating the precursor minute vibration. During the period W2, the head drive circuit 101 outputs the drive signals shown by the pulse waveforms P1, P2 and P3 only at a fifth time t5 equal to the first time t1 first. Through these drive signals, the negative voltage −V is applied to each of channels ch.a, ch.b and ch.c. As a result, as shown in the pulse waveforms P4 and P5, the electric fields of the first and the second actuators are kept at “0”.

The head drive circuit 101 outputs the drive signals shown by the pulse waveforms 91, P2 and P3 only at a sixth time 6 equal to the second time t2. Through these drive signals, the voltage applied to each of channels ch.a, ch.b and ch.c returns to the grounding potential GND. As a result, as shown in the pulse waveforms P4 and P5, the electric fields of the first and the second actuators are kept at “0”.

The head drive circuit 101 outputs the drive signals shown by the pulse waveforms P1, P2 and P3 only at a seventh time t7 equal to the third time t3. Through these drive signals, first, the negative voltage −V is applied to each of channels ch.a, ch.b and ch.c. Next, the positive voltage +V is applied only to the central channel ch.b. As a result, as shown in the pulse waveforms P4 and P5, at a timing when the positive voltage +V is applied only to the central channel ch.b, the electric field “−E” is generated in the first actuator and the electric field “+E” is generated in the second actuator. Through such a fluctuation of the electric field, minute vibration is generated in the pressure chamber 15b corresponding to the channel ch.b. Through the minute vibration, in the nozzle 8 connected with the pressure chamber 15b, the meniscus of the ink vibrates at a level at which the ink is not ejected.

In this way, conventionally, the electric field E having the same potential is generated in the actuator at the time of ejecting ink and at the time of the precursor minute vibration.

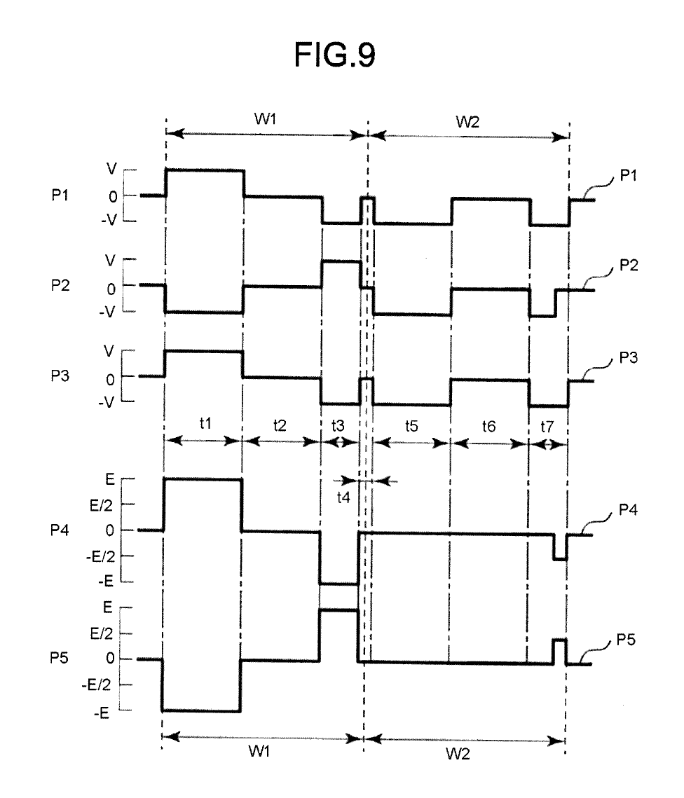

Next, the relationship between the drive signal or the precursor signal of the present embodiment and the electric field generated in the actuator is described with reference to FIG. 9. Similarly to FIG. 8, FIG. 9 shows a case in which among three adjacent channels ch.a, ch.b and ch.c, one ink droplet is ejected from the central channel ch.b, and afterwards, the precursor minute vibration is generated in the central channel ch.b. Further, parts in FIG. 9 which are the same as FIG. 8 are applied with the same marks, and therefore the description thereof is omitted.

By comparing FIG. 9 with FIG. 8, it can be known that the present embodiment differs with the conventional example in the pulse signal (pulse waveform P2) supplied to the channel ch.b at the seventh time t7. The pulse signals (pulse waveforms P1 and P3) that are supplied to two channels ch.a and ch.c located at positions adjacent to the channel ch.b are the same as the conventional example. That is, at the seventh time t7, first, the negative voltage −V is applied to each of channels ch.a, ch.b and ch.c. Next, only the voltage applied to the central channel ch.b returns to the grounding potential GND. As a result, as shown in the pulse waveforms P4 and P5, at the timing when only the voltage applied to the central channel ch.b returns to the grounding potential GND, electric field “−E/2” is generated in the first actuator, that is, in the bulkhead 16a serving as one side of the channel ch.b, and electric field “+E/2” is generated in the second actuator, that is, in the bulkhead 16bserving as the other side of the channel ch.b. Through such a fluctuation of the electric field, minute vibration is generated in the pressure chamber 15b corresponding to the channel ch.b. Through the minute vibration, in the nozzle 8 connected with the pressure chamber 15b, the meniscus of the ink vibrates at a level at which the ink is not ejected.

In this way, in the present embodiment, electric field generated in the actuator at the time of occurrence of the precursor minute vibration, electric field is half as large as that generated at the time of ejecting ink.

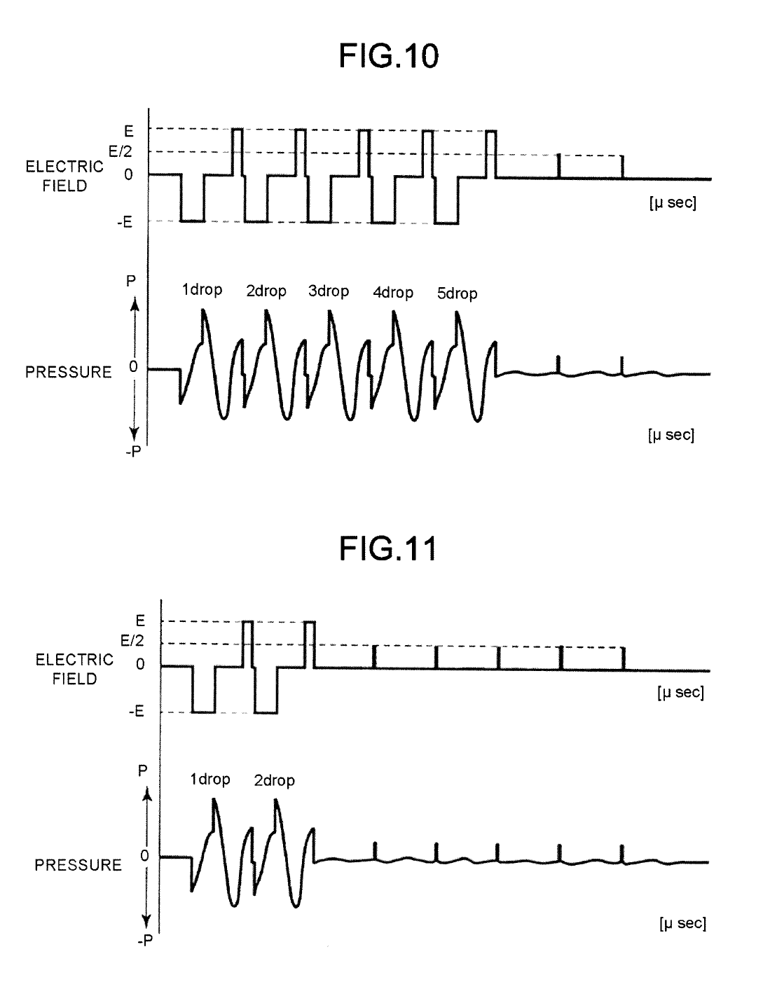

FIG. 10 is a graph illustrating electric field generated in the actuator and pressure in the pressure chamber of the ejecting channel when 5 drops are ejected in a gradation printing in which the maximal number of drops is 7. In this example, among the maximal number of drops, waveform of each of 5 drops is the drive waveform for ejecting the ink droplet and the waveform of each of the residual 2 drops is waveform for the precursor minute vibration.

FIG. 11 is a graph illustrating electric field generated in the actuator and pressure in the pressure chamber of the ejecting channel when 2 drops are ejected in the gradation printing in which the maximal number of drops is 7. In this example, among the maximal number of drops, the waveform of each of 2 drops is the drive waveform for ejecting the ink droplet and the waveform of each of the residual 5 drops is waveform for the precursor minute vibration.

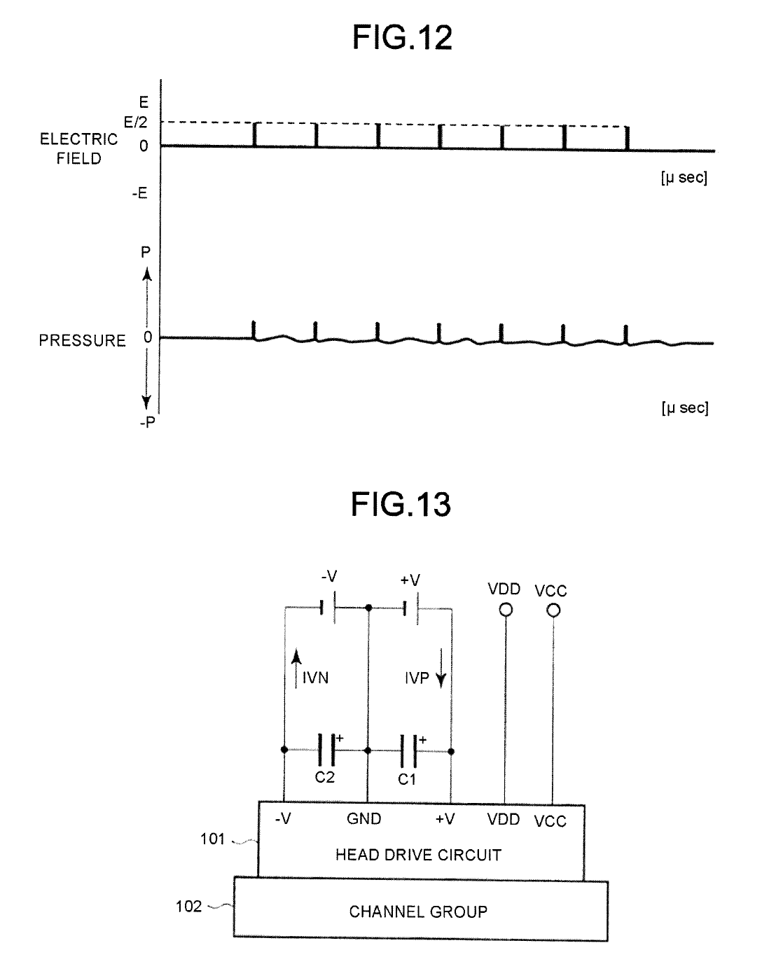

FIG. 12 is a graph illustrating the electric field generated in the actuator and the pressure in the pressure chamber of the ejecting channel when no drop is ejected in the gradation printing in which the maximal number of drops is 7. In this example, the waveform of each of 7 drops which is the maximal number is the waveform for the precursor minute vibration.

As shown in FIG. 10-FIG. 12, even in the gradation printing in which the maximal number of drops is 7, the electric field generated in the actuator at the time of the precursor minute vibration is half as large as the electric field generated at the time of ejecting ink. If the intensity of the electric field becomes half, the pressure in the pressure chamber becomes small when compared with the conventional example. However, as the meniscus of the ink is vibrated in advance at a level at which no ink is ejected from the nozzle 8, the function of the precursor minute vibration is fully achieved.

Thus, the drive current of a case in which the electric field generated in the actuator through the precursor minute vibration to be half as large as the conventional example is considered.

FIG. 13 is a diagram illustrating a measurement circuit of the drive current. As stated above, the head 100 consists of the head drive circuit 101 and the channel group 102. The power sources used in such a head 100 includes a power source VDD for the logic circuit, a power source Vcc for the analog circuit and power sources +V, −V and GND for the head drive.

The measurement circuit arranges a first bypass condenser C1 at a position between a supply terminal of the positive power source +V and a terminal of the grounding potential GND. The measurement circuit arranges a second bypass condenser C2 at a position between a supply terminal of the negative power source −V and the terminal of grounding potential GND. The first and the second bypass condensers C1 and C2 function to charge the actuator rapidly.

The measurement circuit measures a current of a power source line supplied via a wire harness from an external device. Specifically, a current IVP that flows from the positive power source +V to the terminal V of the head drive circuit 101 and a current IVN that flows from the terminal −V of the head drive circuit 101 to the negative power source −V are measured.

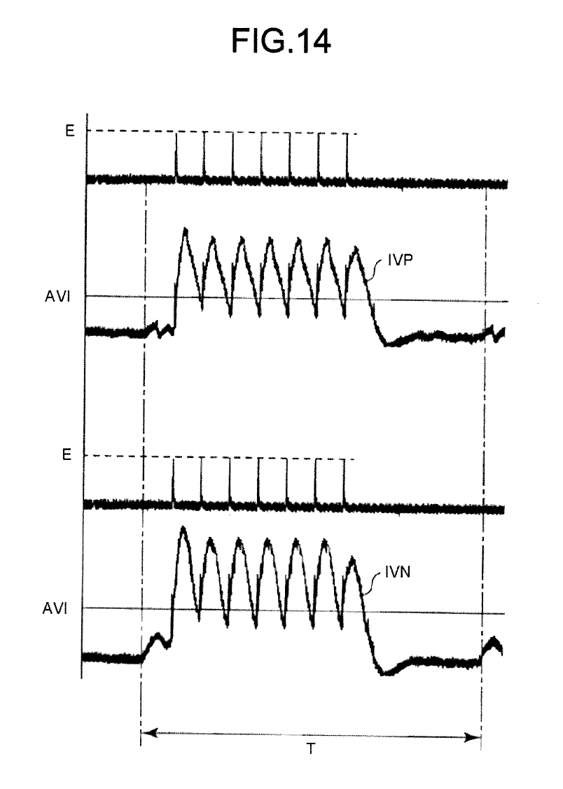

FIG. 14 shows a conventional example. That is, FIG. 14 is a diagram illustrating the drive current IVP and the drive current IVN when the electric field generated in the actuator at the time of the precursor minute vibration is set as E. As measurement conditions, the positive power source is +12,V the negative power source is −12V and the number of drive nozzles is 200. In the example shown in FIG. 14, at the time T, the average current value of the drive current IVP at the positive side is +135 mA and the average current value of the drive current IVN at the negative side is −185 mA.

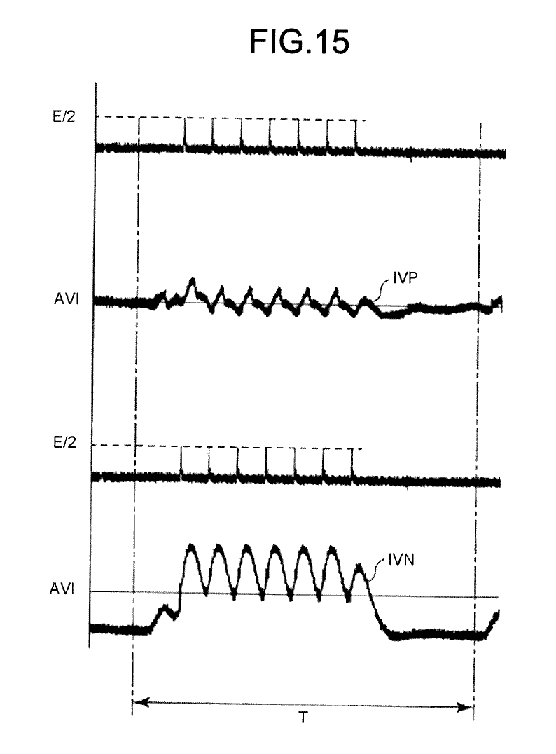

FIG. 15 shows the present embodiment. That is, FIG. 15 is a diagram illustrating a drive current IVP and a drive current IVN when the intensity of the electric field generated in the actuator is E/2 at the time of the precursor minute vibration. The measurement condition is the same as that in the conventional example. In the example shown in FIG. 15, at the time T, the average current value of the drive current IVP at the positive side is 0 mA, and the average current value of the drive current IVN at the negative side is 133 mA.

In this way, the drive currents IVP and IVN can be reduced through setting the electric field generated in the actuator at the time of the precursor minute vibration to E/2. This effect is obvious for the reduction of the power consumption especially in a case in which an image which contains many parts to which ink is not ejected is printed.

Furthermore, the present invention is not limited to the foregoing embodiment.

For example, in the foregoing embodiment, it is described that the electric field generated in the actuator at the time of the precursor minute vibration is set to half as large as the electric field generated in the actuator at the time of ejecting ink; however, the intensity of the electric field is not limited to the half. The electric field generated in the actuator at the time of the precursor minute vibration which is smaller than the electric field generated in the actuator at the time of ejecting ink is applicable as the effect of reducing power consumption can be achieved.

Further, in the foregoing embodiment, the head 100 of a share-mode type is exemplified in which each pressure chamber shares the actuator with adjacent pressure chambers; however, the type of the inkjet head is not limited to this. For example, an inkjet head in which each pressure chamber does not share the actuator with adjacent pressure chambers is also applicable as the effect of reducing power consumption is achieved through setting the electric field generated in the actuator at the time of the precursor minute vibration to be smaller than the electric field generated in the actuator at the time of ejecting ink.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An inkjet head, comprising:
a pressure chamber into which ink is filled;
a nozzle configured to be connected with the pressure chamber;
an actuator configured to change volume of the inside of the pressure chamber to eject an ink droplet from the nozzle connected with the pressure chamber; and
a drive circuit configured to output a drive signal which contains an expansion pulse for increasing the volume of the pressure chamber and a contraction pulse for decreasing the volume of the pressure chamber at the time of ejection of an ink droplet and output a precursor signal for changing the volume of the pressure chamber to a level at which the ink droplet is not ejected from the nozzle at the time of a precursor minute vibration for minutely vibrating ink, wherein
the drive circuit outputs the precursor signal in such a manner that an electric field generated in the actuator according to the precursor signal is smaller than that generated in the actuator according to the drive signal.

2. The inkjet head according to claim 1, wherein the drive circuit outputs the precursor signal in such a manner that the electric field generated in the actuator according to the precursor signal is half as large as the electric field generated in the actuator according to the drive signal.

3. The inkjet head according to claim 1, wherein
the drive circuit outputs a precursor signal for enabling precursor minute vibration to be executed for (N−n) times after a drive signal for ejecting n (n<N) drops when the maximal number of drops in a gradation printing is N.

4. The inkjet head according to claim 2, wherein
the drive circuit outputs a precursor signal for enabling precursor minute vibration to be executed for (N−n) times after a drive signal for ejecting n (n<N) drops when the maximal number of drops in a gradation printing is N.

5. The inkjet head according to claim 3, wherein the drive circuit outputs a precursor signal for enabling precursor minute vibration to be executed for N times which is the maximal number of drops if no ink droplet is ejected.

6. An inkjet printer, comprising:
an inkjet head; and
a pump configured to supply ink in an ink tank to the inkjet head, wherein
the inkjet head further comprising:
a pressure chamber into which ink is filled;
a nozzle configured to be connected with the pressure chamber;
an actuator configured to change volume of the inside of the pressure chamber to eject an ink droplet from the nozzle connected with the pressure chamber; and
a drive circuit configured to output a drive signal which contains an expansion pulse for increasing the volume of the pressure chamber and a contraction pulse for decreasing the volume of the pressure chamber at the time of ejection of an ink droplet and output a precursor signal for changing the volume of the pressure chamber to a level at which the ink droplet is not ejected from the nozzle at the time of a precursor minute vibration for minutely vibrating ink, wherein
the drive circuit outputs the precursor signal in such a manner that an electric field generated in the actuator according to the precursor signal is smaller than that generated in the actuator according to the drive signal.

7. The inkjet printer according to claim 6, wherein
the drive circuit outputs the precursor signal in such a manner that the electric field generated in the actuator according to the precursor signal is half as large as the electric field generated in the actuator according to the drive signal.

8. The inkjet printer according to claim 6, wherein
the drive circuit outputs a precursor signal for enabling precursor minute vibration to be executed for (N−n) times after a drive signal for ejecting n (n<N) drops when the maximal number of drops in a gradation printing is N.

9. The inkjet printer according to claim 7, wherein
the drive circuit outputs a precursor signal for enabling precursor minute vibration to be executed for (N−n) times after a drive signal for ejecting n (n<N) drops when the maximal number of drops in a gradation printing is N.

10. The inkjet printer according to claim 8, wherein
the drive circuit outputs a precursor signal for enabling precursor minute vibration to be executed for N times which is the maximal number of drops if no ink droplet is ejected.
